(19) United States
(12) Patent Application Publication
(10) Pub. No.: US 2026/0011902 A1
(43) Pub. Date: Jan. 8, 2026

(54) WAVEGUIDE ASSEMBLY FOR USE WITH LAUNCHER-IN-PACKAGE DEVICES

(71) Applicant: NXP B.V., Eindhoven (NL)

(72) Inventors: Waqas Hassan Syed, Helmond (NL); Adrianus Buijsman, Nijmegen (NL); Harish Nandagopal, Veldhoven (NL); Pieter Lok, Leur (NL)

(21) Appl. No.: 19/252,960

(22) Filed: Jun. 27, 2025

(30) Foreign Application Priority Data
Jul. 4, 2024 (EP) 24186596.3

(51) Int. Cl. H01P 3/12; H01P 3/16; H01P 3/18

(52) U.S. Cl. CPC H01P 3/12; H01P 3/16; H01P 3/18

(57) ABSTRACT

Disclosed is a waveguide assembly comprising: a stack of first and second laminate structure and a substrate having a conductive surface; the first and second laminate structure each comprise a plurality of metal layers with dielectric material therebetween; the first has at least one opening therethough configured to propagate millimetre-wavelength or microwave radiation therethrough; the second laminate structure has an elongate cavity therein, extending in a first direction, having conductive sidewalls and forming an air-filled waveguide (AWG) for the millimetre-wavelength or microwave radiation; the opening is partially over an end of the elongate cavity; the opening is aligned with the elongate cavity in the first direction, and a sidewall of the opening along a width of the opening is offset from the end of the cavity by an offset distance which is less that the width of the opening.

### CROSS-REFERENCE TO RELATED APPLICATIONS

This application claims priority under 35 U.S.C. § 119 to European patent application no. 24186596.3, filed Jul. 4, 2024, the contents of which are incorporated by reference herein.

### FIELD OF THE DISCLOSURE

The present disclosure relates, in general, to waveguide assemblies. It is particularly relevant to waveguide assemblies for use in conjunction with so-called “launcher in package” packaged semiconductor devices, in which a semiconductor device is packaged to launch high-frequency (that is to say typically millimetre wavelength or microwave) RF signals directly into waveguides, or into free space.

### BACKGROUND

With recent, and accelerating, advances in higher frequency RF applications (typically operating in the millimetre-wavelength or microwave wavelength ranges), such as 5G and 6G communication and radar applications which are particularly cost sensitive, such as for example automotive radar applications, low-cost integration techniques, processes, products and assemblies are becoming of increasing interest. One such set of products and assemblies are so-called “launcher in package” (“LiP”) packaged semiconductor devices. Such packaged semiconductor device and assemblies typically integrate RF launchers into a package itself, such that the signal propagates from the LiP device along air-filled waveguides (AWG), towards one or more antennas, thereby reducing the number of components required in transmitters, receivers or transceivers.

FIG. 1 shows, schematically, a device assembly 100, comprising a launcher-in-package packaged semiconductor device 110 (sometimes referred to herein as a “semiconductor die 110”) mounted, for example by means of a ball grid array of electrically conductive balls or pillars 112, on a first substrate 120 which may be for example a printed circuit board (PCB). The first substrate may be referred to as an application PCB and may typically have mounted thereon further active or passive electronic components such as transistors, resistors, capacitors and like. The first substrate 120 includes one or more openings 122 therethrough which are aligned with launchers in the packaged semiconductor device 110 in order to propagate high-frequency RF electromagnetic radiation directly through the first substrate 120. The openings 122 are dimensioned to act as waveguides for signals from the LiP packaged semiconductor die 110. The first substrate 120 is mounted on a second substrate 130, which may typically be an injection-molded metalized plastic component or a machined metal component. The second substrate includes air-filled waveguides (AWG) 132 therein, which typically act to spread out the RF signal beyond the footprint of the semiconductor device and to the locations of one or more antennas 134. The antennas may be, for example slots array antennas (not visible in FIG. 1 since they extend in and out of the plane of the paper).

The second substrate 130 includes at least one 90° bend 142 for each signal which propagate through the first substrate 120, in order to change the propagation direction from vertical to horizontal. Such 90° bends are known to be lossy, since they can have a reflection loss due the high reactive impedance part which reflects power-back to the IC in case of the TX and to the antenna in case of the RX; moreover, it is known to reduce the losses arising from such bends by extending the waveguide by a so-called “stub”, by either quarter, three-quarter, five-quarter, etc. wavelength, for a short-circuit stub, beyond the bend area such as that shown at 144. However, these stubs occupy space on the substrate, and generally put constraints on the compactness of the device.

The signal propagates along the AWG 132, to an antenna 134, for onwards transmission into free space. The antenna may be for example a multi-slot antenna array having a plurality of slots 136 (only one of which is visible in the plane of FIG. 1). The second substrate 130 may be connected to the first substrate 120 by means of, for example, screws or bolts. The tolerances involved in such mechanical connection may result in losses in the propagation of the millimetre wavelength or microwave signal; these may be reduced or minimized by using techniques such as a bandgap engineered connection, commonly referred to as EBG (electronic bandgap, or electromagnetic bandgap) materials (in which, for example, the surface is corrugated in order to reduce radiation losses), as shown schematically at 138.

### SUMMARY

According to a first aspect of the present disclosure, there is provided a waveguide assembly comprising: a stack of a first laminate structure (220), a second laminate structure (230), and a substrate (250) having a conductive surface proximal to the second laminate structure; wherein the first laminate structure comprises a plurality of metal layers (222, 224) with dielectric material (226) therebetween, and has at least one opening (228) therethough having an opening length and a smaller opening width and configured to propagate millimetre-wavelength or microwave radiation through the laminate structure; wherein the second laminate structure (230) comprises a plurality of metal layers (232, 234), with dielectric material therebetween (236), and an elongate cavity (238) therethrough having a cavity width and extending in a first direction therealong and having conductive sidewalls and forming an air-filled waveguide (AWG) for the millimetre-wavelength or microwave radiation; wherein the opening is partially over an end, or end region, in a length direction of the elongate cavity such that the opening length is aligned with the cavity width, and a sidewall (242) of the opening along the opening length is offset from the end of the elongate cavity by an offset distance which is less that the opening width. The offset between the opening and the waveguide formed from elongate cavity may act to reduce the reflective losses thus improving the transmission of the signal in the proximity of the 90° transition and thereby reduce losses.

In one or more embodiments, the waveguide assembly further comprises a semiconductor device mounted on the first laminate structure and configured to propagate millimetre-wavelength or microwave radiation at least a one of into and out of the opening. The waveguide assembly may thus be used as at least one of transmitter, receiver or transceiver.

In one or more embodiments the second laminate structure is a printed circuit board having top and bottom metal layers with dielectric therebetween. A PCB may be a particularly low-cost component for use in such embodiments.

In one or more embodiments the second laminate structure comprises a multi-layer printed circuit board having top and bottom metals layer, and at least a third metal layer therebetween.

In one or more embodiments the elongate cavity comprises a ledge across its width at the end. The ledge may act to further reduce the mismatch losses. An upper surface of the ledge may be formed of the third metal layer. Provision of the third metal layer may provide a convenient etch stop for forming the elongate cavity with a ledge there-across.

The ledge may extend a distance of 50% to 60% of the waveguide width. In other embodiments, the ledge may extend between about 40% and about 70% of the waveguide width.

In one or more embodiments, the opening length in the first laminate structure is a waveguiding ‘a’ dimension and the width of the opening in the first laminate structure is a waveguiding ‘b’ dimension.

In one or more embodiments a distance between a bottom metal layer (224) of the first laminate structure and the conductive surface of the substrate (250) is a, waveguiding ‘b’ dimension. In one or more embodiments the offset is between 25% and 75% of the opening length.

The substrate may be a metal foil.

In one or more embodiments the first laminate structure is affixed to the second laminate structure by first solder regions therebetween. Furthermore, in one or more embodiments the second laminate is affixed to the substrate by second solder regions therebetween.

According to another aspect of the present disclosure, there is provided a waveguide assembly comprising: a stack of a first printed circuit board (PCB), a second PCB, and a metal foil substrate; wherein the first PCB comprises a plurality of metal layers with dielectric material therebetween, and has at least one waveguiding opening therethough having an opening length and a smaller opening width; wherein the second PCB comprises a plurality of metal layers with dielectric material therebetween, and an elongate cavity therethrough having a cavity width and extending in a first direction therealong; wherein the elongate cavity has conductive sidewalls and, with an upper surface of the metal foil substrate and a lower metal layer of the first PCB, forms an air-filled waveguide; wherein the opening is partially over an end of the elongate cavity, such that the opening length is aligned with the cavity width, and a sidewall of the opening along the opening length is displaced from the end of the elongate cavity by an offset distance which is less that the opening width.

In one or more embodiments, the waveguide assembly further comprises a semiconductor device mounted on the first PCB and configured to propagate millimetre-wavelength or microwave radiation at least a one of into and out of the opening.

In one or more embodiments the second PCB comprises a multi-layer printed circuit board having top and bottom metals layer, and at least a third metal layer therebetween.

In one or more embodiments the elongate cavity comprises a ledge across its width at the end.

In one or more such embodiments an upper surface of the ledge is formed of the third metal layer.

In one or more such embodiments the ledge extends between 50% and 60% of the width of the waveguide.

### BRIEF DESCRIPTION OF THE DRAWINGS

Reference will now be made to the accompanying drawings, which are not necessarily drawn to scale, and wherein:

FIG. 1 shows, schematically, a conventional device assembly, comprising a launcher-in-package packaged semiconductor device;

FIG. 2 shows, schematically, a waveguide assembly 200 having a packaged semiconductor device 210 mounted thereon, according to one or more embodiments;

FIG. 3 shows, schematically, a semi-transparent plan view of an end section of elongate cavity 238, according to one or more embodiments;

FIG. 4 shows the same end section of elongate cavity 238 as a sectional view through Y-Y′ of FIG. 3;

FIG. 5 shows a simple cross-section W-W′, through the assembly shown in FIG. 3, including the LiP packaged semiconductor device;

FIG. 6 shows a simple cross-section X-X′, through the assembly shown in FIG. 3, including the LiP packaged semiconductor device;

FIG. 7 shows a simple cross-section Y-Y′, through the assembly shown in FIG. 3, including the LiP packaged semiconductor device;

FIG. 8 shows a simple cross-section Z-Z′, through the assembly shown in FIG. 3, including the LiP packaged semiconductor device;

FIG. 9, shows a cross-sectional view Z-Z′ through the assembly shown in FIG. 3, including the LiP packaged semiconductor device;

FIG. 10 shows, schematically, a semi-transparent plan view of an end section of elongate cavity, according to one or more other embodiments;

FIG. 11 shows the same end section of elongate cavity as a sectional view through P-P;

FIG. 12 shows a simple cross-section, along P-P′, through the assembly shown in FIG. 10, including the LiP packaged semiconductor device;

FIG. 13 shows a cross-sectional view, along P-P′, through the assembly shown in FIG. 10, including the LiP packaged semiconductor device;

FIG. 14 shows, schematically, a semi-transparent plan view of an end section of elongate cavity, according to one or more further embodiments, and

FIG. 15 shows the same end section of elongate cavity as a sectional view through Q-Q.

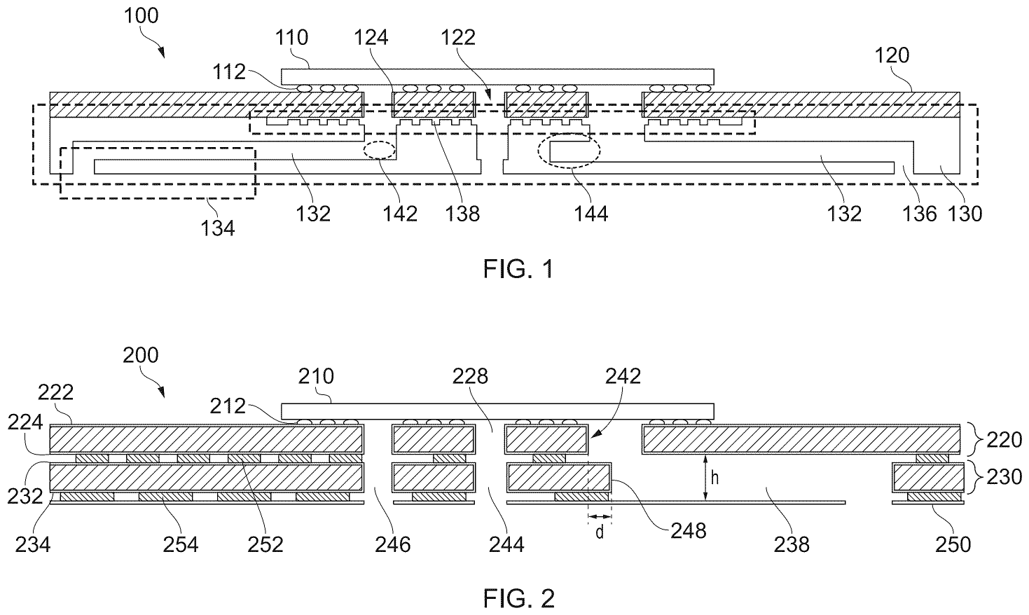

### DETAILED DESCRIPTION

FIG. 2 shows, schematically, a waveguide assembly 200 having a packaged semiconductor device 210 mounted thereon, typically by means of a ball grid array of solder balls or pillars 212. The waveguide assembly 200 comprises a stack of a first laminate structure 220, a second laminate structure 230, and a substrate 250 having a conductive surface proximal to the second laminate substrate. The first laminate structure 220 may be a conventional printed circuit board such as an FR4 PCB and comprises a plurality of metal layers 222, 224 with dielectric material 226 therebetween. Although not shown in FIG. 2, the PCB or first laminate structure 220 may have additional components such as, without limitation, transistors, capacitors, resistors and the like mounted thereon. The nature of the circuits and components on the PCB will depend on the application and the PCB or first laminate structure 220 may therefore be referred to as an application PCB. At least the top metal layer is thus patterned to provide interconnects between the various circuit components. Depending on the application, the bottom metal layer may also be patterned or may be continuous in order to provide a continuous ground plane.

The PCB or first laminate structure 220 has at least one opening 228 therethough configured to propagate millimetre-wavelength or microwave radiation through the laminate structure. Millimetre-wavelength or microwave radiation may conveniently be loosely described as mm-wave radiation. That is to say, the opening acts as a short waveguide section. The skilled person will be familiar that the dimensions of the waveguide depend on the frequency of radiation to be waveguided. Thus, for applications using radiation in a range of 60 to 90 GHz (generally referred to as E Band radiation), the opening may have a length or ‘a’ dimension of 3.1 mm, and a width or ‘b’ dimension of 1.55 mm. Conversely, for applications using radiation in a range of 75 to 110 GHZ (generally referred to as W-band radiation), the opening may have a length or ‘a’ dimension of 2.54 mm, and a width or ‘b’ dimension of 1.27 mm. The opening is generally lined with conductive material such as solder or other metallic material in order to operate as an effective waveguide, although in some embodiments, the metallic material could be replaced or partially replaced by and EBG material.

The second laminate structure 230 comprises a plurality of metal layers 232, 234, with dielectric material 236 therebetween. The second laminate structure may be a conventional PCB, fabricated from FR4 or similar material, or may be a multilayer laminate including one or more additional metal layers beyond the top and bottom metal layer, in which the additional metal layers are buried between layers of dielectric such as FR4.

The second laminate structure 230 includes at least one elongate cavity 238 therein, having conductive sidewalls and forming an air-filled waveguide (AWG) for the millimetre-wavelength or microwave radiation. The at least one elongate cavity 238 is sometimes referred to herein as an “AWG 238” or “cavity 238”. The elongate cavity 238 extends in a first direction generally away from the LiP packaged semiconductor device 210. In the case of multiple elongate cavities each acting as a separate waveguide, the second laminate structure may be referred to as a “fanout” arrangement, since it acts to spread out the signals away from the package semiconductor device. FIG. 2 illustrates three such cavities or AWGs, of which one AWG 238 extends towards the right of the paper, and the other two, labelled as 244 and 246, extend in (or out) of the plane of the paper.

As can be seen in FIG. 2 in the example of the AWG 238, one end 248 of the cavity 238 is located such that the opening in the first laminate structure 220 is generally partially over the end of the elongate cavity. As will be explained in more detail hereinbelow, the opening is aligned with the elongate cavity in the first direction and offset from the end of the cavity by an offset distance, d, which is less that the width of the opening. In particular, a sidewall 242 of the opening along a width of the opening is offset from the end of the cavity by the offset distance, d, which is less that the width of the opening.

The second laminate structure 230 is mechanically connected to the first laminate structure 220 by means of solder patches or pads 252. The thickness of the solder patches or pads 252 is generally well defined and may be further controlled by means of various known techniques such as limiting the area of reflow during the soldering process, or by including incompressible spacers within the solder in order to define the separation. As a result, the radiation losses associated with the poorly defined size of the gaps between the first substrate 120 (e.g., application PCB) and the second substrate 130 (e.g., antenna structures) of conventional assemblies, which is generally associated with mechanical assembly by means of screws, bolts or the like, may be significantly reduced or eliminated.

Similarly, the second laminate structure 230 is also mechanically connected to the substrate 250 by means of solder pads or patches 254, the thickness of which may be accurately controlled as above. The solder patches or pads 252 and 254 may be provided as a so-called land Grid array (LGA); alternatively and without limitation, they may be provided as a ball grid array (BGA). Furthermore, the mechanical connection between the first laminate structure and second laminate structure, and between the second laminate structure and the substrate may be provided by alternative means, such as by use of a conductive adhesive. Alternatively, mechanical joints, of suitable galvanically conductive construction material, other than solder or adhesive could be used for one or both of these connections. As shown in FIG. 2, the elongate cavities in the second laminate structure 230 generally are through-cavities, that is to say all material including any top metal, dielectric, and the bottom metal are removed along the cavity. The top and bottom walls of the AWG formed by elongate cavity 238 are thus generally not defined by top metal layer 232 and bottom metal layer 234 of the second laminate structure 230, but by the bottom metal of the first laminate structure 220, and the conductive top surface of the substrate 250, respectively. As a result, the height (that is to say the ‘b’ dimension) of the AWG is defined by the total thickness of the second laminate structure, including top and bottom metal layers, together with the thickness of the solder pads or patches 252 and 254.

The substrate 250 may be a single metal layer such as a metal foil or metal strip. Alternatively, it may be a composite substrate such as a metallised dielectric. In general, in order to provide the conductive bottom wall of the substrate in the region of the elongate cavity, it has a conductive upper surface.

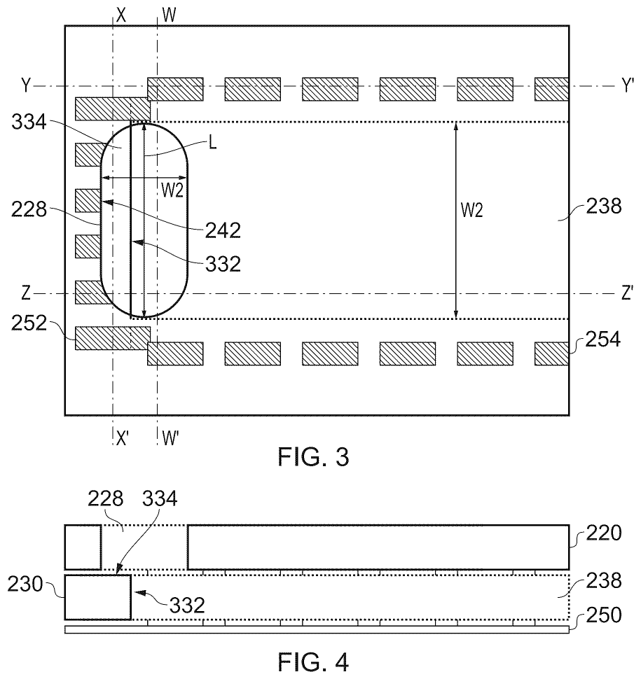

FIG. 3 shows, schematically, a semi-transparent plan view of an end section of elongate cavity 238, according to one or more embodiments. FIG. 4 shows the same end section of elongate cavity 238 as a sectional view through Y-Y′. The cavity has a width W2 which corresponds to the “a” dimension of the waveguide as the signal propagates towards the right of the FIG. as shown. The FIG. also shows the opening 228 in the first laminate structure 220. The opening has a smaller dimension (or width) W1, which corresponds to the ‘b’ dimension of the waveguide as the signal propagates down (into the paper as shown) from the LiP packaged semiconductor device (not shown) to the elongate cavity 238. A length L of the opening corresponds to the “a” dimension of the waveguide as the signal propagates down from the LiP packaged semiconductor device to the elongate cavity 238. Solder patches or pads 252 provide mechanical connection between the first and second laminate structures 220 and 230. Further solder pads or patches 254 provide mechanical connection between the second laminate structure 230 and the substrate 250. There is an offset between the sidewall 242 of the opening in the first laminate structure, and the end face 332 of the elongate cavity in the second laminate structure. The radiation propagating through the waveguide formed by the opening 228 thus encounters and is disrupted by an upper surface 334 of the second laminate structure, as it approaches the 90° transition towards horizontal propagation.

Although waveguides such as the opening 228 are generally rectangular, the skilled person will appreciate that the corners of the rectangles may be rounded without significant deterioration of the way cutting properties. Thus, the opening 228 is shown as having rounded ends (in the example shown the ends are semicircular being the limit case of rounding off corners). The extent to which the corners or ends are rounded depends on the manufacturing processes used to provide the opening through the first laminate structure 220, and the elongate cavity in the second laminate structure 230. For example, in the case that the opening is produced by milling, the degree of rounding may depend on the diameter of the milling tool.

The thickness of the second laminate structure is generally defined by the frequency of the radiation anticipated in the waveguide, and may typically be in the order of 2 to 3 mm. The thickness of the first laminate structure is typically not critical and may be chosen for convenience. For example, a typical application PCB may have a thickness of 1.5 to 3 mm, depending on its size and the nature of the application.

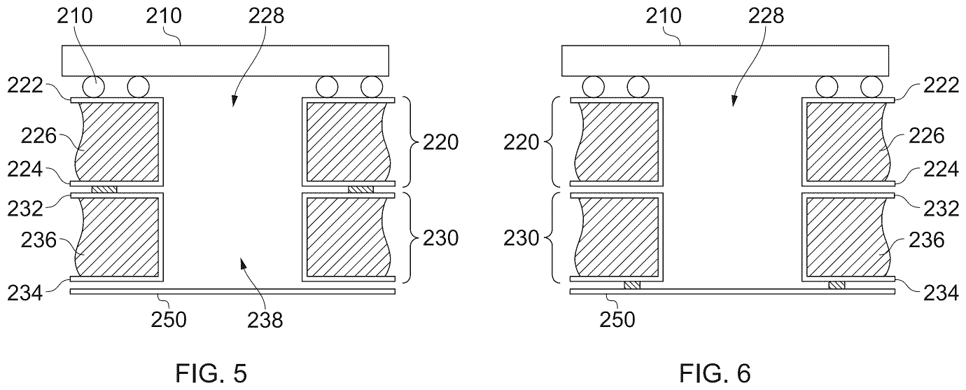

Turning now to FIG. 5 and FIG. 6, these show cross-sections W-W′ and X-X′, through the assembly shown in FIG. 3, including the LiP packaged semiconductor device 210. The sections shown in FIG. 5 and FIG. 6 are simple cross-sections (rather than cross-sectional views) and thus do not show material out of the plane of the cross-section. They show an opening 228 in the first laminate structure 220, which is located under a launcher (not shown) of the LiP packaged semiconductor device 210. The LiP packaged semiconductor device 210 is mounted on the first laminate structure 220, for example by means of ball grid array 212. The opening 228 is provided as a through-hole which penetrates each of the top metal layer 222, dielectric material 226, and bottom metal layer 224. The opening is partially over an end of the elongate cavity, and at the position of the cross-section W-W′, the opening 228 is indeed above part of the elongate cavity 238. The elongate cavity forms a through-hole through the second laminate structure 230, and thus penetrates the top metal layer 232, the dielectric material 236, and the bottom metal layer 234. Solder pads or patches 252 or 254, which may be part of an LGA, are visible between the first and second laminate structures 220 and 230.

Turning now to FIG. 6, this shows a cross-section X-X′ through a different part of the opening 228. As already mentioned in relation to FIG. 5, opening 228 penetrates the top metal layer 222, the dielectric 226, and the bottom metal layer 224. However, as is apparent in FIG. 3, this section through the opening is beyond the end of the elongate cavity 238. Thus, as can be seen in the FIG., the second laminate structure 230 is intact in this region and the metal layers 232 and 234 and the dielectric 236 are all continuous. Solder pads or patches 254 or 252, which may be part of an LGA, are visible between the second laminate structure 230 and the substrate 250.

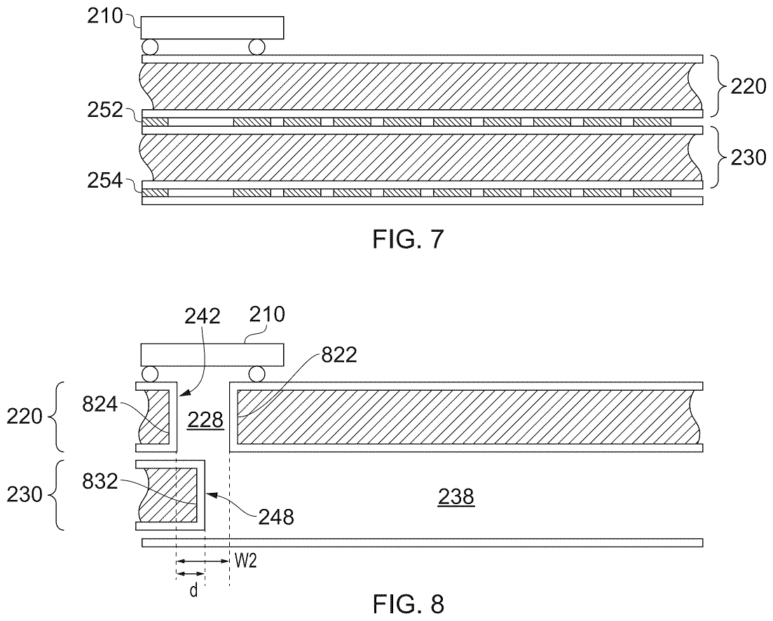

Turning now to FIG. 7 and FIG. 8, these show cross-sections Y-Y′ and Z-Z′, through the assembly shown in FIG. 3, including the LiP packaged semiconductor device 210. Again, the sections are simple cross-sections (rather than cross-sectional views) and thus do not show any material out of the plane of the cross-section. The cross-sections Y-Y′ and Z-Z′ are in the direction of the elongate cavity 238. However, that shown along Y-Y′, in FIG. 7, is not aligned to the cavity. This cross-section thus shows continuous, uninterrupted layers, of the first laminate structure 220 and the second laminate structure 230 without any openings therethrough. The LGA or solder patches or pads 252 and 254 between the first and second laminate structures, and the second laminate structure and the substrate 250, respectively, are shown. As will be immediately apparent to the skilled person, the section through Y-Y′ is not especially revealing, but may assist the reader in understanding the details of the section Z-Z′ shown in FIG. 8, which is parallel to that shown in FIG. 7 and reveals both the opening 228 through the first laminate structure 220 and the elongate cavity 238 in the second laminate structure 230. As can be seen, the sidewall 242 of the opening is offset from the end 248 of the elongate cavity 238 by a distance d. The distance d is less than the width W2 of the opening. The magnitude of the offset d is not critical, but typically lies within a range of 25 to 75% of the width W2 which, as described above, corresponds to the ‘b’ dimension of the waveguide through the laminate structure. The side walls 822 and 824 of the opening 228 are lined with metal, to assist in the waveguide the action through the first laminate structure 220. Furthermore, the end wall 248 of the elongate cavity 238 in the second laminate structure 230 is also metallized, having a metal layer 832 deposited thereon.

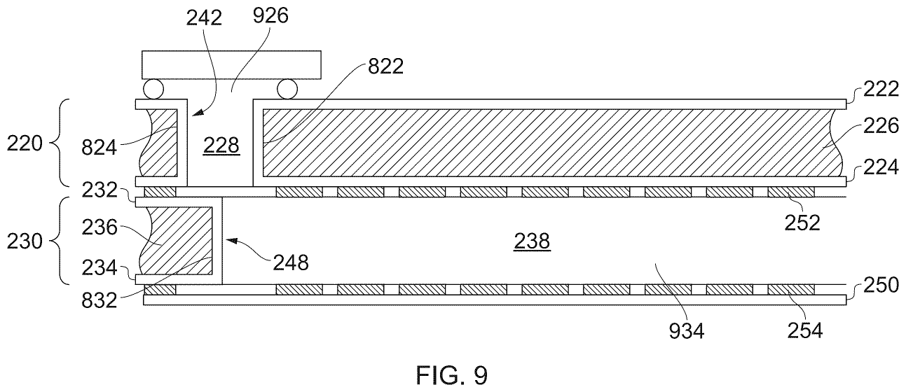

FIG. 9, shows a cross-sectional view Z-Z′ through the assembly shown in FIG. 3, including the LiP packaged semiconductor device 210. Since FIG. 9 is a cross-sectional view rather than a simple cross-section, it shows material out of the plane of the cross-section. Thus, in addition to showing the metal layers 222 and 224 and the dielectric 226 of first laminate structure 220, and the metal on the side walls 822 and 824 of the opening 228, it also shows metal 926 on the end wall of the opening 228. Similarly, in addition to showing the metal layers 232 and 234 and the dielectric 236 of second laminate structure 230, and the metal 832 on the end face of the elongate cavity 238, it also shows the metal 934 on the side wall of the elongate cavity 238. Furthermore, the solder patches or pads 252 and 254 which typically form an LGA as discussed above between the two laminate, and the second laminate structure and the substrate, respectively, are also visible.

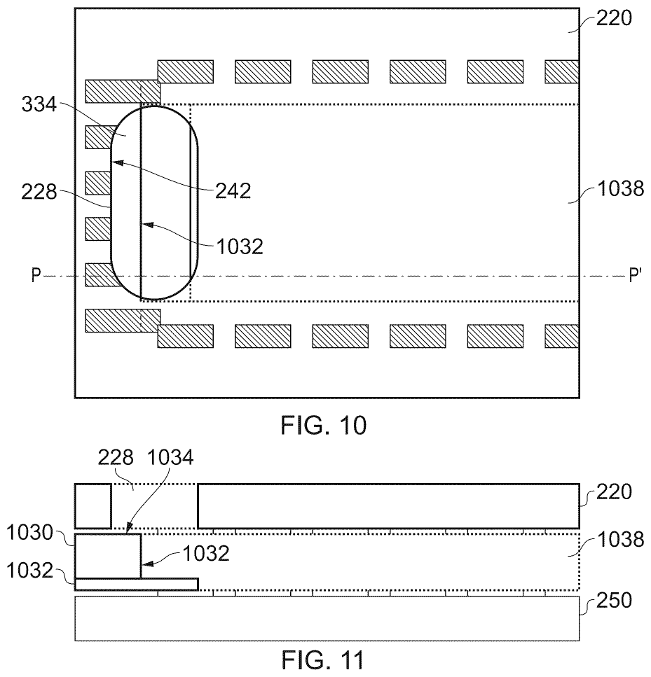

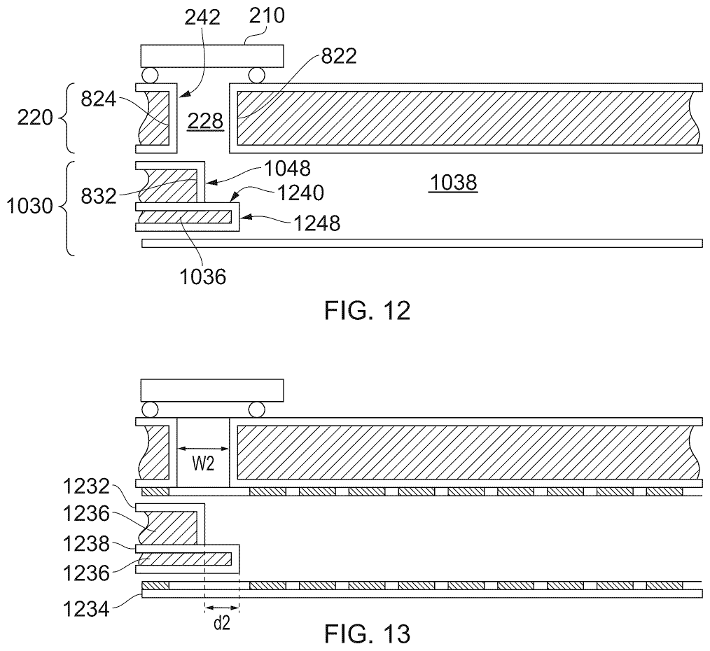

FIG. 10 shows, schematically, a semi-transparent plan view of an end section of an elongate cavity 1038, according to one or more other embodiments. FIG. 11 shows the same end section of elongate cavity 1038 as a sectional view through P-P′. The first laminate structure 220 is the same as that described above and has an opening 228 therethrough. Elongate cavity 1038, in the second laminate structure 1030, is similar to elongate cavity 238 except towards the end which is proximal to the opening 228. An end wall 1048, which may also be referred to as an end-face, of the elongate cavity is offset from the sidewall 242 of the opening 228, as in the embodiments described above, such that the radiation propagating through the opening 228 sees a first ridge or ledge 1034 in the 90° transition region; however in the embodiment shown in FIG. 10, there is a further protruding ledge or ridge 1036 which extends beyond the end wall 1032 of the elongate cavity into the elongate cavity 1038. As will become more apparent from the description of FIGS. 12 and 13 hereinbelow, a top surface of the ledge or ridge 1034 may be defined by a third metal layer 1238 in the laminate structure 1030. Providing such a ledge or ridge, 1034, which provides a second step, in conjunction with the step provides by the offset between the end of the waveguide, and the opening in the first laminate structure, may assist in reducing the radiative losses associated with the 90° waveguide transition: in particular, the process tolerance and the second step can help to make the 90° bend more robust.

FIG. 12 and FIG. 13 show a simple cross-section and a cross-sectional view, respectively, along P-P′, through the assembly shown in FIG. 10, including the LiP packaged semiconductor device 210. The second laminate structure 1030 includes top and bottom metal layers 1232 and 1234, together with the third metal layer 1238 which is buried between two layers of dielectric material 1236. The distance d2 by which the ledge or ridge 1036, having upper surface 1240, extends into the elongate cavity is not critical, but for typical applications may be of the order of 25% to 75% of the width W2 of the opening 228, which width it will be recalled is equal to the dimension ‘b’ of the waveguide. The end face 1248 of the ridge or ledge 1036 is metallized as shown.

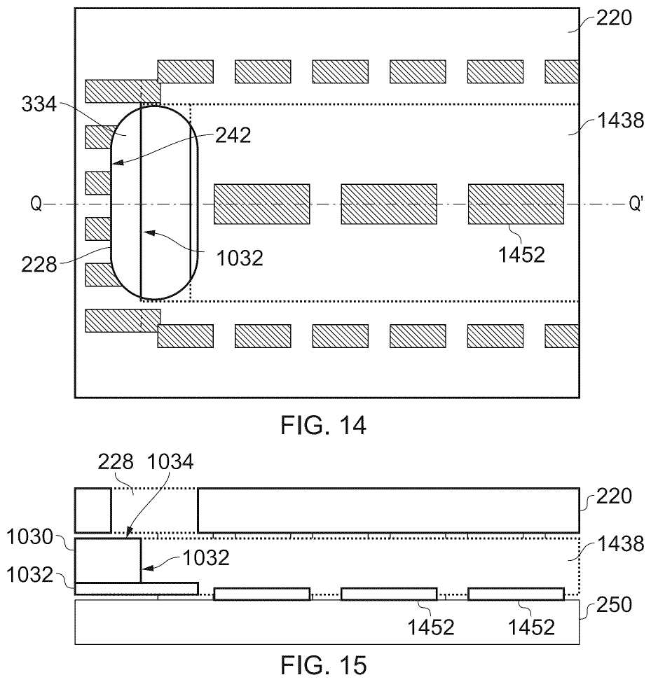

FIG. 14 shows, schematically, a semi-transparent plan view of an end section of elongate cavity 1438, according to one or more further embodiments, and FIG. 15 shows the same end section of elongate cavity 1438 as a sectional view through Q-Q. The first laminate structure 220 is the same as that described above and has an opening 228 therethrough. Elongate cavity 1438, in a second laminate structure 1030, is similar to a one of elongate cavities 238 and 1038 (in the example shown, 1038) except for ridges 1452 along at least a part of its length proximal to the end wall 1032. The ridges may be discrete patches across a part or a whole of the waveguide formed by elongate cavity 1438. The patches may be affixed to the conductive upper surface of the substrate 250. Alternatively and without limitation, the ridges may be a continuous layer of varying thickness along the length of the elongate cavity, again across a part or the whole of the waveguide. In the case of the continuous layer, it may be affixed to the substrate 250 or may be the substrate itself. The waveguide dimension d (that is to say the height of the waveguide as shown in FIG. 15) is locally reduced in the region of the ridges. The thickness reduction is not critical but may typically been within a range of one 5% to 25%, and could be even as high as 80% or more, of its height (that is to say, waveguide dimension ‘b’). The ridges may act to enhance propagation along the waveguide and in particular to reduce the reflection losses and to further enhance the effect from the one or two step ledge.

In one or more other embodiments, ridges may be provided along a top wall of the waveguide formed by the elongate cavity 1438. Such ridges may be provided by, for example solder pads or patches attaching to a bottom metal layer of the first laminate structure 220. Similar to that described above with respect to FIG. 15, the ridges may alternatively be provided by a continuous layer of varying thickness. The thickness variation may be produced by known manufacturing techniques, such as for instance by pressing or stamping the continuous layer. In yet other embodiments, the ridges or other artefacts which produce a variation height of the waveguide may be provided on both the top and bottom walls of the waveguide.

While some of the embodiments described herein pertain to a use of a capacitor to facilitate compensating for coupling (e.g., parasitic or inductive coupling), in some instances other types or kinds of components (potentially in lieu of, or in addition to, a capacitor) may be utilized. More generally, an impedance network may be utilized to realize an electromagnetic profile that may serve to compensate for one or more electromagnetic conditions.

Aspects of this disclosure may readily lend themselves to conventional circuit, device, and PCB manufacturing/fabrication techniques. For example, aspects of this disclosure may be implemented with little-to-no additional cost (in terms of, e.g., package development or innovation) or energy consumption/power dissipation relative to conventional techniques, while at the same time providing additional benefits in terms of achieving/realizing isolation. In this respect, aspects of this disclosure represent substantial improvements relative to conventional technologies in terms of practical applications involving circuit design and assembly/fabrication/manufacture. In brief, and as demonstrated herein, the various aspects of this disclosure are not directed to abstract ideas. To the contrary, the various aspects of this disclosure are directed to, and encompass, significantly more than any abstract idea standing alone.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated or constructed to achieve the same or a similar purpose may be substituted for the specific embodiments shown. This disclosure is intended to cover any and all adaptations or variations of various embodiments. Combinations of the above embodiments, and other embodiments not specifically described herein, are contemplated by the subject disclosure.

For instance, one or more features or aspects from one or more embodiments can be combined with one or more features or aspects of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1-13. (canceled)

14. A waveguide assembly comprising:
a stack of a first laminate structure, a second laminate structure, and a substrate having a conductive surface proximal to the second laminate structure;
wherein the first laminate structure comprises a plurality of metal layers with dielectric material therebetween and has at least one opening therethough having an opening length and a smaller opening width and configured to propagate millimetre-wavelength or microwave radiation through the first laminate structure;
wherein the second laminate structure comprises a plurality of metal layers with dielectric material therebetween and an elongate cavity therethrough having a cavity width and extending in a first direction therealong and having conductive sidewalls and forming an air-filled waveguide for the millimetre-wavelength or microwave radiation; and
wherein the opening is partially over an end of the elongate cavity, such that the opening length is aligned with the cavity width, and a sidewall of the opening along the opening length is offset from the end of the elongate cavity by an offset distance which is less that the opening width.

15. The waveguide assembly of claim 14, further comprising a semiconductor device mounted on the first laminate structure and configured to propagate millimetre-wavelength or microwave radiation at least a one of into and out of the opening.

16. The waveguide assembly of claim 14, wherein the second laminate structure is a printed circuit board having top and bottom metal layers with dielectric therebetween.

17. The waveguide assembly of claim 14, wherein the second laminate structure comprises a multi-layer printed circuit board having top and bottom metals layer, and at least a third metal layer therebetween.

18. The waveguide assembly of claim 17, where the elongate cavity comprises a ledge across a width of the elongate cavity at the end.

19. The waveguide assembly of claim 18, wherein an upper surface of the ledge is formed of the third metal layer.

20. The waveguide assembly of claim 18, wherein the ledge extends between 50% and 60% of the width of the waveguide.

21. The waveguide assembly of claim 14, wherein the opening length is a waveguiding ‘a’ dimension and the width of the opening in the first laminate structure is a waveguiding ‘b’ dimension.

22. The waveguide assembly of claim 14, wherein a distance between a bottom metal layer of the first laminate structure and the conductive surface of the substrate is the same as the width of the opening in the first laminate structure.

23. The waveguide assembly of claim 14, wherein a distance between a bottom metal layer of the first laminate structure and the conductive surface of the substrate is a waveguiding ‘b’ dimension.

24. The waveguide assembly of claim 14, wherein the offset is between 25% and 75% of the opening width.

25. The waveguide assembly of claim 14, wherein the substrate is a metal foil.

26. The waveguide assembly of claim 14, wherein the first laminate structure is affixed to the second laminate structure by first solder regions therebetween.

27. The waveguide assembly of claim 14, wherein the second laminate structure is affixed to the substrate by second solder regions therebetween.

28. A waveguide assembly comprising:
a stack of a first printed circuit board (PCB), a second PCB, and a metal foil substrate;
wherein the first PCB comprises a plurality of metal layers with dielectric material therebetween, and has at least one waveguiding opening therethough having an opening length and a smaller opening width;
wherein the second PCB comprises a plurality of metal layers with dielectric material therebetween, and an elongate cavity therethrough having a cavity width and extending in a first direction therealong;
wherein the elongate cavity has conductive sidewalls and, with an upper surface of the metal foil substrate and a lower metal layer of the first PCB, forms an air-filled waveguide; and
wherein the opening is partially over an end of the elongate cavity, such that the opening length is aligned with the cavity width, and a sidewall of the opening along the opening length is displaced from the end of the elongate cavity by an offset distance which is less that the opening width.

29. The waveguide assembly of claim 28, further comprising a semiconductor device mounted on the first PCB and configured to propagate mm-wave radiation at least a one of into and out of the opening.

30. The waveguide assembly of claim 28, wherein the second PCB comprises a multi-layer printed circuit board having top and bottom metals layer, and at least a third metal layer therebetween.

31. The waveguide assembly of claim 30, where the elongate cavity comprises a ledge across its width at the end.

32. The waveguide assembly of claim 31, wherein an upper surface of the ledge is formed of the third metal layer.

33. The waveguide assembly of claim 32, wherein the ledge extends between 50% and 60% of the width of the waveguide.
